(19) United States
(12) Patent Application Publication
(10) Pub. No.: US 2020/0140010 A1
(43) Pub. Date: May 7, 2020

(54) Force-Rated Tie Rod Assembly

(71) Applicant: Bryon Ross, Watsonville, CA (US)

(72) Inventor: Bryon Ross, Watsonville, CA (US)

(21) Appl. No.: 16/181,714

(22) Filed: Nov. 6, 2018

(51) Int. Cl. B62D 7/20; E01F 15/14; E02B 3/26; F16F 3/12

(52) U.S. Cl. CPC B62D 7/20; E01F 15/146; F16F 2224/02; F16F 3/12; F16F 2224/0208; E02B 3/26

(57) ABSTRACT

A flexing tie rod assembly has a steel cable having a diameter and a length, metal cable ends joined rigidly to opposite ends of the steel cable, the cable ends adapted to join to adaptive tie rod ends, a steel coil spring surrounding the cable for full length of the cable between the metal cable ends, and a polymer casement enclosing the cable and coil spring from metal cable end to opposite metal cable end. The strength characteristics of the cable, the coil spring and the polymer casement result in a compressive force rating below which the tie rod assembly stays straight under linear compression, and above which the tie rod assembly buckles to some degree without relative rotation of the cable ends.

### BACKGROUND OF THE INVENTION

### 1. Field of the Invention

The present invention is in the technical field of apparatus for mitigating shock on elements of an apparatus.

### 2. Discussion of the State of the Art

Mechanical steering assemblies is one circumstance wherein apparatus to mitigate shock may be useful. In this technical area, tie rods are a common and critical component. The function of a tie rod is to tie one component to another component in a manner that the components may work together such as in an automobile steering mechanism to enable left and right turning of the front wheels of a vehicle or, in a vessel where the steering linkage controls the left and right swing of a rudder or a pair of rudders and or the angle of a propeller motor if not fixed. Tie rods may also be used in structures, typically to provide tensile stability between two or more separate components of a structure or architecture such as tie rods between pillars, for example.

A tie rod's movement is constrained as for example, in a rack and pinion steering assembly. The tie rods in such an assembly control the steering angles and alignment of the wheels or rudders connected to the steering system linkage. FIG. 1 is a simple architectural overview of a steering architecture 100 in an automobile that utilizes a pair of tie rods according to existing art. Steering architecture 100 is controlled by a steering wheel 101 mounted onto a steering column 102. Steering column 102 is mounted to a steering link shaft 104 via an upper universal joint 103. Steering link shaft 104 is mounted to a pinion shaft 106 that fits into a rack and pinion housing 107.

Tie rods 110 (passenger side) and 111 (drivers' side) are connected to a steering rack 108 inside a rack and pinion housing 107. The tie rod ends are represented at each end of the depicted rods 110 and 111. Tie rod arms 112 (connected to tie rod 110) and 113 (connected to tie rod 112), connect the steering assembly to a wishbone arm 117 via a swivel pin connection 119 on the passenger side and to a wishbone arm 116 via a swivel pin connection 118 on the driver side. Wheels 120 (passenger wheel) and 121 (driver side wheel) are depicted herein in broken boundary. Tie rod arms 112 and 113 control the angle of stub axles 115 and 114 respectively wherein the motion is transferred from the steering wheel through the column, shaft, and tie rods moving in unison to achieve parallel turn angling of wheels 120 and 121 left or right.

A typical tie rod used in existing art for an automobile steering architecture like tie rods 110 and 111 of architecture 100 of FIG. 1 is depicted in elevation in FIG. 2. Tie rod (110, 111 identical parts) includes a removably installed tie rod end 201 and a removably installed tie rod end 202 that are threaded onto the ends of center rod 203. Tie rod ends 201 and 202 may be identical parts or differently configured parts depending upon the application.

A tie rod may fail under stress at the center rod or at either or both tie rod ends. Force exerted on the steering system from the outside, like from a tire colliding with a fixed surface, like a curb or a pothole, can exert more load on a tie rod than it may be able to sustain, and may result in a cracked or bent tie rod, or damage to one or another component in the steering assembly. Likewise, tie rod ends may be damaged by external force.

Therefore, what is clearly needed is a flexible tie rod body assembly that may be constructed to withstand a threshold compressive force but may flex if the force exerted is greater than the threshold force. The threshold force would be that maximum force that would be expected under normal operating conditions without encountering a sudden increase, such as from striking a curb, for example.

### BRIEF SUMMARY OF THE INVENTION

In one embodiment of the invention a flexing tie rod assembly is provided, comprising a steel cable having a diameter and a length, metal cable ends joined rigidly to opposite ends of the cable, the cable ends adapted to join to adaptive tie rod ends, a steel coil spring surrounding the cable for full length of the cable between the metal cable ends, and a polymer casement enclosing the cable and coil spring from metal cable end to opposite metal cable end. The strength characteristics of the cable, the coil spring and the polymer casement result in a compressive force rating below which the tie rod assembly stays straight under linear compression, and above which the tie rod assembly buckles to some degree without relative rotation of the cable ends.

In one embodiment the polymer casement penetrates between coils of the coil spring to the steel cable. Also, in one embodiment the assembly further comprises adaptive tie rod ends common to an automotive steering assembly. In one embodiment the assembly further comprises adaptive tie rod ends comprising flanges orthogonal to the length of the tie rod assembly, the flanges having a bolt pattern adapted to bolt the flanges to a plane surface. And in one embodiment the coil spring has coil spacing sufficient to avoid coil contact when buckled.

In another aspect of the invention a force-absorbing barrier is provided, comprising a free-floating structure having an outer and an inner surface, an anchor structure having an outer and an inner surface, with the outer surface joined rigidly to a substantially larger and heavier structure, and a plurality of tie rods each comprising a steel cable having a diameter and a length, metal cable ends joined rigidly to opposite ends of the cable, the cable ends adapted to join to adaptive tie rod ends, a steel coil spring surrounding the cable for full length of the cable between the metal cable ends, and a polymer casement enclosing the cable and coil spring from metal cable end to opposite metal cable end, the strength characteristics of the cable, the coil spring and the polymer casement providing a compressive force rating below which the tie rod assembly stays straight under linear compression, and above which the tie rod assembly buckles to some degree without relative rotation of the cable ends, the tie rods joined substantially orthogonally by flanged ends to the inner surfaces of the free-floating structure and the anchor structure. A force exerted against the outer surface of the free-floating structure, the force greater than the collective, additive force rating of the plurality of tie rod assemblies, will cause the free-floating structure to move toward the anchor structure, and individual ones of the tie rod assemblies to temporarily buckle, and to exert a counterforce on the inner surface of the free-floating structure, the counterforce increasing with buckling until the movement stops, and the free-floating structure moves away from the anchor structure until the tie rods return to a straight aspect.

In one embodiment the outer surface of the anchor structure is affixed to a dock for absorbing force from a docking ship. And in one embodiment the outer surface of the anchor structure is affixed to a structure along a roadway or raceway to absorb force imparted by a vehicle colliding with the outer surface of the free-floating structure.

### BRIEF DESCRIPTION OF THE SEVERAL VIEWS OF THE DRAWINGS

FIG. 1 is a front elevation view of a typical steering system architecture according to existing art.

FIG. 2 is a side elevation view of a typical tie rod assembly according to existing art.

FIG. 3A is a side elevation view of a tie rod assembly according to an embodiment of the present invention.

FIG. 3B is a side elevation view of the tie rod assembly of FIG. 3A encased in a protective polymer sleeve according to an embodiment of the invention.

FIG. 4 is a side elevation view of the tie rod body of FIG. 3B with different tie rod ends.

FIG. 5A is a side elevation view of the tie rod assembly of FIG. 4 under a force F1 less than or equal to the force rating of the assembly.

FIG. 5B is a side elevation view of the tie rod assembly of FIG. 5A under force F2 greater than the force rating of the assembly.

FIG. 6 is a broken elevation view of a force distribution and absorption system according to an embodiment of the present invention.

### DETAILED DESCRIPTION OF THE INVENTION

The inventor provides, in embodiments of the invention, a unique tie rod assembly that may be rated for a specific force, but wherein force greater than that specific force may cause the tie rod to flex rather than to fail, or cause failure of another element connected to the tie rod. The present invention is described in enabling detail using the following examples, which may describe more than one relevant embodiment falling within the scope of the present invention.

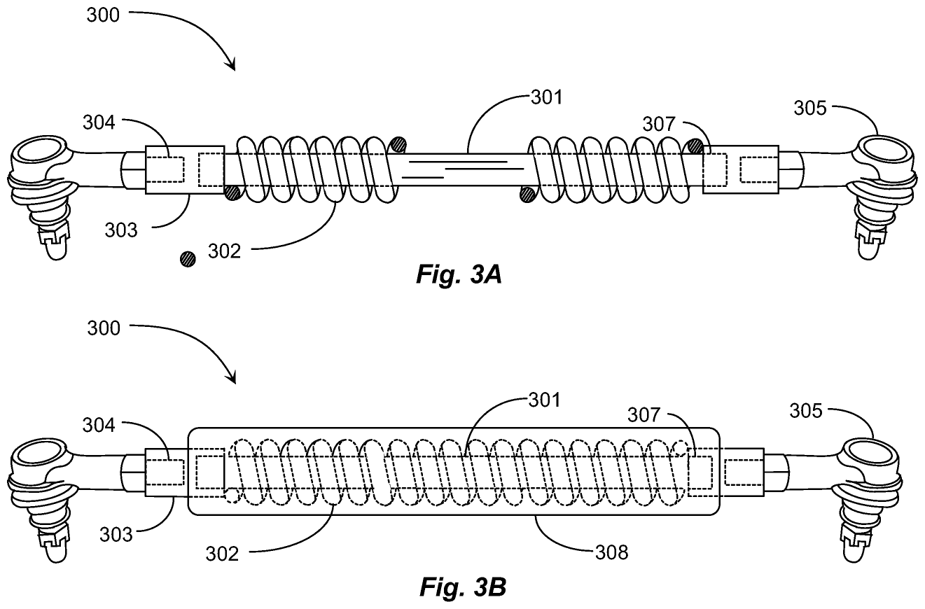

FIG. 3A is a side elevation view of a tie rod assembly 300 according to an embodiment of the present invention. Tie rod assembly 300 is adapted by construction to be resilient up to and equal to a specific force rating but will flex when a force is exerted against the assembly that is greater than the rated force. Tie rod assembly 300 may be provided in a variety of sizes and force ratings that may be called for in different steering architectures including those steering linkages in stock and modified automobiles, in boats, in airplanes, and in some industrial equipment.

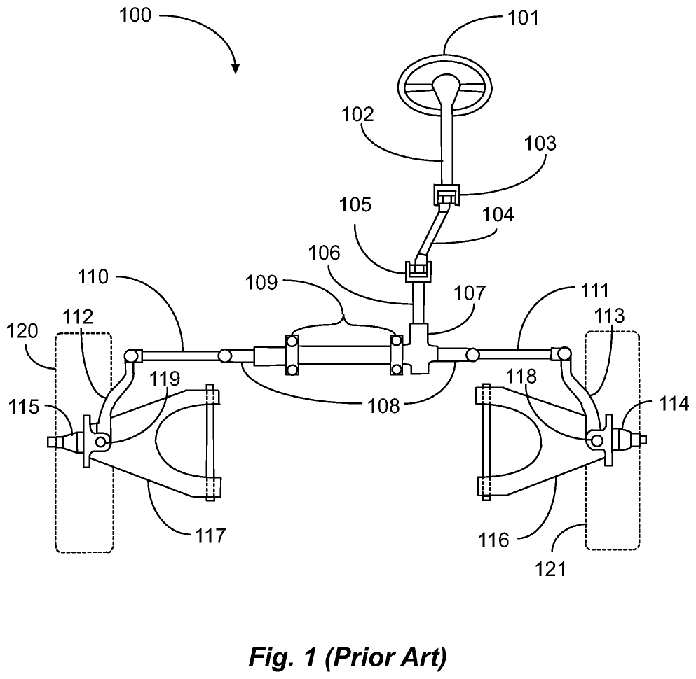

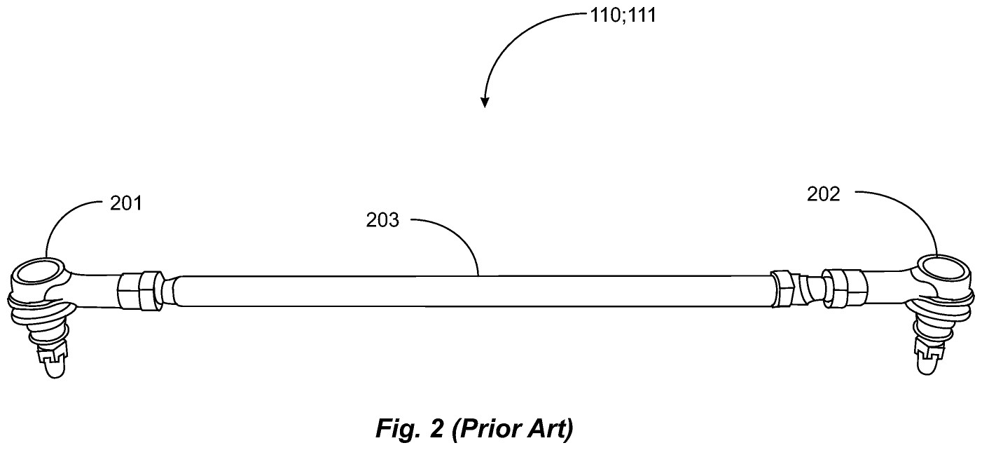

Tie rod assembly 300 may be provided as an aftermarket part to replace existing conventional tie rods 110 and 111 depicted in FIG. 1 and discussed in the background section of this specification. Tie rod 300 comprises a center steel cable 301. Steel cable 301 may be a stiff braided cable made from durable stainless-steel strands. Steel cable 301 may or may not include a jacket or sleeve (not illustrated) of durable polymer or other resistive material that may flex with the cable. Center cable 301 may be rated for tensile strength and type of steel and may be provided in different lengths and diameters as may be required in different tie rod architectures. For an automotive steering system such as that depicted in FIG. 1, the diameter and length of the cable may be comparable to the diameter and length of the center tie rod bodies of tie rods 110 and 111.

Tie rod assembly 300 in one embodiment comprises two steel tie rod end seats 303 to connect to center cable 301 and to provide installment locations for tie rod ends. Tie rod end seats 303 may be solid rod annular parts of an outside diameter that is sufficiently larger than the diameter of cable 301. For example, if cable 301 is one half of an inch in diameter then tie rod end seats 303 may be three quarters of an inch to one inch in diameter. Tie rod end seats 303 have in this embodiment a cable intercept bore 307 or other relief feature 307 machined to a specified depth that has an inside diameter larger than the diameter of cable 301 to enable the cable end to be inserted and welded to seat the cable end to the tie rod end seat. In another embodiment, a cable intercept bore like bore 307 may be provided substantially centered on the cable interface side of tie rod end seat 303 and may be machine tapped to accept a threaded post (not depicted) that may be provided as the end of the cable where the cable end is welded to the threaded post. There may be a variety of ways that cable 301 is connected securely to end elements.

Tie rod assembly 300 in one embodiment includes a steel reinforcement spring 302, depicted herein with a center portion of the spring removed to show the cable beneath. Spring 302 may be a flex-rated spring that covers the entire length of cable body 301. The inside diameter of the coil of spring 302 may be just larger than the outer diameter of steel cable 301 to enable slipping the spring linearly over the cable during the assembly process. In one embodiment, spring 302 is installed linearly over cable 301 before the last tie rod end seat 303 is welded or otherwise fixed to the cable. In one embodiment the spring have flat ends that lie proximate to end seats 303. An important purpose of the spring is to allow bowing of the tie rod under compression above the threshold level, and to cause the tie rod to return to a straight aspect when the excessive force is released.

Tie rod end seats 303 in one embodiment comprise substantially centered and threaded bore features 304. Bore features 304 are adapted to accept the threaded post ends of tie rod ends 305. Tie rod end 305 represents any stock tie rod end that may be available depending on the architecture and design considerations of the steering linkage. In one embodiment, cable 301 may be coated with an insulative material that will flex with the part and insulate the steel of the cable from the steel of the spring. Spring 302 may be similarly coated (insulative coatings not depicted).

FIG. 3B is a side elevation view of tie rod assembly 300 of FIG. 3A encased in a protective polymer sleeve according to an embodiment of the invention. Tie rod assembly 300 may be encased in a polymer sleeve 308 to protect spring 302 and cable 301, and to avoid excessive wear due to relative friction, or from debris that may otherwise lodge in the assembly. Sleeve 308 may run the entire length of the tie rod cable and past the points where spring 301 is retained on both ends of the tie rod. The method of attachment of the sleeve over the tie rod assembly may be linear placement and heat shrinking wherein a substantial portion of the sleeve material invades the space between spring coils of spring 302. In one embodiment, sleeve 308 extends past tie rod seat end components 303 leaving the threaded bore exposed for tie rod ends to be removed and replaced without obstructing the sleeve material. In other embodiments the polymer material may be installed by casting in a mold.

Tie rod assembly 300 has a force rating described in further detail below in this specification. The force rating is the force tie rod assembly 300 will withstand before flexing from the straight linear profile of the assembly. A compressive variable force exerted in normal operation will be less than the force rating for tie rod assembly 300, and therefore not great enough to flex the assembly. The resistance of a tie rod to flexure in embodiments of the invention is a combination of characteristics of the cable 301, the coil spring 302 and the polymer enclosure 308.

Tie rod ends 305 are typical of those in the automobile industry and tie rod assembly 300 is assumed applicable to an automotive steering system like system 100 described relative to FIG. 1 in the background section of this specification.

Referring now to FIG. 1, tie rod assembly 300 may replace the existing assemblies 110 and 111 as an aftermarket automobile part. In one embodiment, the existing tire rod ends on assemblies 110 and 111 may be retained (if in good shape) for use with the new tie rod body assembly 300.

The force rating of the tie rod assembly 300 may be selected for the type of automobile, for example, truck or passenger, make and model, etc. The assembly will not flex under typical loads caused by driving, turning, or off-road use. Flex of the assembly may occur if an external force greater than that of the force rating of the assembly is exerted on the tie rod assembly. For example, if wheel 121 were to encounter a side of a road barrier and is violently shifted along the turn angle of the wheel to the left or right, exerting a force on the linkage transferred to the tie rod assembly of greater than the force rating value, a tie rod assembly like assembly 300 will flex, absorbing the force and simultaneously allowing wheel 121 to depart from a rigid parallel relationship with wheel 120. This may enable the affected wheel to conform more to the surface plane or curve of the barrier while the tie rod is flexed. When the amount of force drops below the force rating value, the assembly regains the linear rigid profile for normal driving.

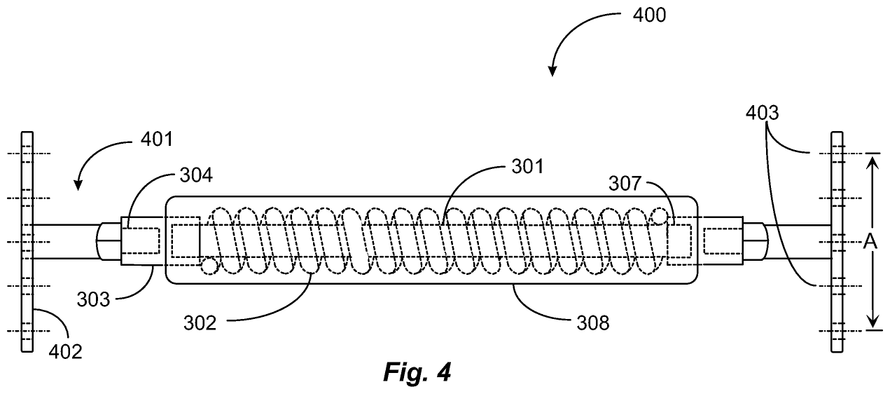

FIG. 4 is a side elevation view of a tie rod assembly 400 with different tie rod ends than that in FIGS. 3A and 3B. Tie rod assembly 400 includes a tie rod body assembly comprising cable 301, spring 302, jacket polymer 308, and tie rod end seats 303, as detailed in tie rod assembly 300 of FIG. 3B. In this embodiment, tie rod assembly 400 is adapted as a tie between a movable structure and a fixed or anchored structure. Tie rod assembly 400 includes tie rod ends 401 in place of tie rod ends 305 of tie rod assembly 300 of FIG. 3B.

Tier rod end 401 comprises a mounting flange 402 having a thickness and a geometric flange area that may be circular, rectangular, or in another geometric profile. Mounting flange 402 may be a steel disk fixed orthogonally to the tie rod stem, the stem including the threaded center post that fits into the tie rod end seat on the tie rod body assembly. In this example, tie rod assembly 400 is adapted for installation between two substantially vertical surfaces. Mounting flange 402 in one embodiment comprises a pattern of bolt holes 403 placed through the flange to accept mounting hardware. The diameter of mounting flange 402 may be significantly larger than the diameter of the tie rod body assembly and may be governed by spacing requirements between multiple assemblies mounted adjacently to be bolted to vertical surfaces. Dimension A for the bolt pattern may be three inches, for example, where the assembly body diameter is one inch. If spacing allows, the bolt pattern and flange diameter may be proportionally larger such as a five-inch flange to a one-inch body or other proportional relationships may be observed.

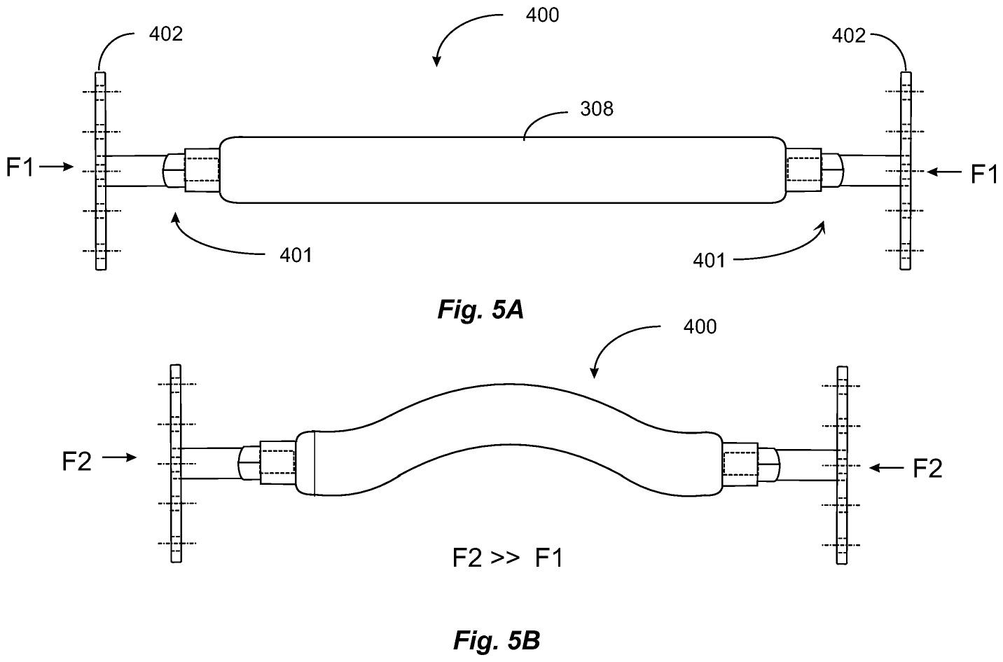

FIG. 5A is a side elevation view of tie rod assembly 400 of FIG. 4 under a force F1 less than or equal to the force rating of the assembly. Tie rod assembly 400 is resilient and retains a rigid profile under normal load pressure. Force (F1) represents a load value exerted directly along a centerline of assembly 400. In this case F1 may be less than or equal to the force rating value (amount of force required to flex) of tie rod assembly 400. Tie rod assembly 400 remains rigid under sudden or sustained force F1. If tie rod assembly 400 is installed between a fixed or anchored structure and a movable structure, then the force F1 may come into the body assembly through the flange on the free-floating side where the force translates through the body assembly to the fixed structure.

FIG. 5B is a side elevation view of tie rod assembly 400 of FIG. 5A under a sudden or sustained external force F2. In this case, force F2 is greater than F1 and exceeds the maximum force rating of the tie rod assembly, causing the center cable and spring to flex absorbing the excess force. The result is a shock-absorbing effect allowing the movable barrier to give under the force. The amount of flex may be small to great without damaging the spring and cable components of the tie rod body assembly.

The depiction of flexure described with reference to FIGS. 5A and 5B is the same for tie rods having ends adapted for automotive steering use. The force F2 may be thought of as a force exerted when a wheel of the automobile encounters a curb or other obstacle, resulting in a force exerted along the length of the tie rod, greater than the rated force, causing the tie rod to momentarily buckle, and then return to straight aspect when the force drops below the rated force.

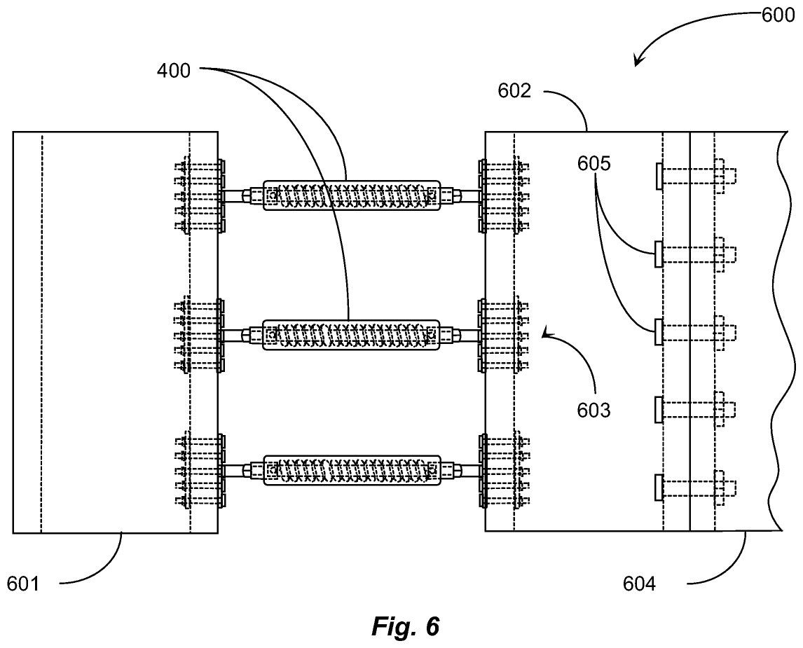

FIG. 6 is an elevation view of a force distribution and absorption system 600 according to an embodiment of the present invention. System 600 may include two otherwise free-floating structures tied together using multiple tie rod assemblies 400 wherein the assembly is then mounted to an anchored structure 604. A structure 601 is depicted having a hollow interior, relatively thick walls with an opening at the top and bottom of the structure. Structure 601 may be a thick-walled polymer unit or a fabricated wooden structure, or a steel structure depending on the type of barrier required. Structure 601 is a movable structure joined to an anchor structure 602 by multiple tie rod assemblies 400 by sets of mounting hardware 603. Structure 602 may also be a free-floating structure and may be the same structure dimensionally as structure 602 wherein structure 602 may be mounted to a fixed structure 604 using bolt and nut hardware 605.

Tie rod assemblies 400 may be equally spaced apart in rows or columns or in other patterns to cover most of the interfacing surface of structure 601 and at the other end structure 602. Structure 602 may be mounted in this embodiment to fixed structure 604 and either structure 601 or 602 might be utilized as the free-floating barrier structure in this example. The amount of space between the innermost faces or mounting surfaces of the barrier is controlled by the overall uniform length of the tie rod assemblies 400 in the assembly of the barrier. The individual tie rod assemblies may be scaled down in overall length for smaller space or scaled up for larger applications having a larger space between tied surfaces.

In one example, structure 601 may be a face plate on a boat dock where structure 604 represents the anchored portion of the dock and 602 represents a fixed matching face plate fastened to the fixed portion of the dock using heavy bolts and nuts. An example of system 600 may include a boat dock having free-floating barriers on the side and on the end of the dock where boats may contact the dock. Another example may be a racing car guard rail or barrier. In one embodiment, a portion of a wall of a building may be protected from impact using a free-floating barrier wall section set off the anchored wall surface using the multiple tie rods. In another embodiment, a large diameter pole or large diameter round abutment might be modified with a free-floating exterior where the tie rods include mounting flanges shaped for the curvature of the mounting surface.

In use, force may be applied to the outer surface of structure 601 causing the tie rod assemblies 400 to flex if the force exerted is greater than the sum of the force rating of the tie rod body assemblies. In this example force may come into the barrier surface of the free-floating barrier of the system at an angle of impact not necessarily a straight on or orthogonal impact. For example, if the barrier is impacted at a shear angle the multiple tie rod assemblies may flex in a uniform direction and spring back to a linear profile once the force is below the force rating of the parts. It is also noted herein that the spacing of and number of units supplied to tie the free-floating barrier to a fixed structure may play a part in increasing the overall force resistance of the barrier per square foot. This may be accomplished by installing more parts to a smaller area of square footage of the barrier surface.

It will be apparent to one with skill in the art that the force distribution and absorption system of the invention including individual tier rod assemblies may be provided using some or all the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

It will also be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented within the scope of the invention. The invention is limited only by the breadth of the claims below.

I claim:

1. A flexing tie rod assembly, comprising:
a steel cable having a diameter and a length;
metal cable ends joined rigidly to opposite ends of the cable, the cable ends adapted to join to adaptive tie rod ends;
a steel coil spring surrounding the cable for full length of the cable between the metal cable ends; and
a polymer casement enclosing the cable and coil spring from metal cable end to opposite metal cable end;
wherein the strength characteristics of the cable, the coil spring and the polymer casement result in a compressive force rating below which the tie rod assembly stays straight under linear compression, and above which the tie rod assembly buckles to some degree without relative rotation of the cable ends.

2. The tie rod assembly of claim 1 wherein the polymer casement penetrates between coils of the coil spring to the steel cable.

3. The tie rod assembly of claim 1 further comprising adaptive tie rod ends common to an automotive steering assembly.

4. The tie rod assembly of claim 1 further comprising adaptive tie rod ends comprising flanges orthogonal to the length of the tie rod assembly, the flanges having a bolt pattern adapted to bolt the flanges to a plane surface.

5. The toe rod assembly of claim 1 wherein the coil spring has coil spacing sufficient to avoid coil contact when buckled.

6. A force-absorbing barrier, comprising:
a free-floating structure having an outer and an inner surface;
an anchor structure having an outer and an inner surface, with the outer surface joined rigidly to a substantially larger and heavier structure; and
a plurality of tie rods each comprising a steel cable having a diameter and a length, metal cable ends joined rigidly to opposite ends of the cable, the cable ends adapted to join to adaptive tie rod ends, a steel coil spring surrounding the cable for full length of the cable between the metal cable ends, and a polymer casement enclosing the cable and coil spring from metal cable end to opposite metal cable end, the strength characteristics of the cable, the coil spring and the polymer casement providing a compressive force rating below which the tie rod assembly stays straight under linear compression, and above which the tie rod assembly buckles to some degree without relative rotation of the cable ends, the tie rods joined substantially orthogonally by flanged ends to the inner surfaces of the free-floating structure and the anchor structure;
wherein, a force exerted against the outer surface of the free-floating structure, the force greater than the collective, additive force rating of the plurality of tie rod assemblies, will cause the free-floating structure to move toward the anchor structure, and individual ones of the tie rod assemblies to temporarily buckle, and to exert a counterforce on the inner surface of the free-floating structure, the counterforce increasing with buckling until the movement stops, and the free-floating structure moves away from the anchor structure until the tie rods return to a straight aspect.

7. The force-absorbing barrier of claim 6 wherein the outer surface of the anchor structure is affixed to a dock for absorbing force from a docking ship.

8. The force-absorbing barrier of claim 6 wherein the outer surface of the anchor structure is affixed to a structure along a roadway or raceway to absorb force imparted by a vehicle colliding with the outer surface of the free-floating structure.
